(19) United States
(12) Patent Application Publication
(10) Pub. No.: US 2001/0042600 A1
(43) Pub. Date: Nov. 22, 2001

(54) Label stuck device for disks

(76) Inventor: Jui Chin Liao, Taipei (TW)

Correspondence Address: Dougherty & Troxell, ONE SKYLINE PLACE, SUITE 1404, 5205 LEESBURG PIKE, FALLS CHURCH, VA, 22401, US

(21) Appl. No.: 09/855,552

(22) Filed: May 16, 2001

(30) Foreign Application Priority Data
May 22, 2000 (TW) 089208621

(51) Int. Cl. B32B 31/00

(52) U.S. Cl. 156/582

(57) ABSTRACT

A label stuck device for disks comprises a base part and a cover part. The base part provides upright rim projections on the periphery. An inner diameter enclosed by the rim projection or the rim projections corresponds to an outer diameter of a standard disk. An integral locating post extends upright from the center of the base part with an outer diameter thereof corresponding to a central hole of the standard disk. The cover part has an outer diameter thereof corresponding to the outer diameter of the standard disk. A central axial hole of cover part has a diameter corresponding to the outer diameter of the locating post and the cover part provides two opposite upright edge parts. The edge parts equally space apart to each other with respect to the axial hole with a distance between the edge parts corresponding to a width of a second one of the disks. When a glue side of a label is arranged to face upward with a central hole thereof passed through by the locating post, the standard disk is faced downward and passed through by the locating post. A press force is exerted to the press cover fitting with the locating post to allow the label being tightly adhered to the standard disk. Furthermore, the locating post passes through the small disk facing downward so that a label can be adhered to the small disk as well.

### BACKGROUND OF THE INVENTION

1. Field of the Invention

The present invention relates to a label stuck device for disks, and particularly to a label stuck device, with which a standard sized disk and a small sized disk can be respectively adhered with a label firmly and easily.

2. Description of Related Art

It is known that a disk has been very popularly used as a media record in our daily life. Because a disk can store a great deal of data, it is widely applied to audio and video records such as a compact disk (CD), a video compact disk (VCD), a laser disk (LD), a digital video disk (DVD), . . . , and so on. Hence, the disk leads to a development of a size reduced media record for being able to carry about easily. In addition, a disk type of personal introduction and name card, which have been developed in the recent years, are available in the market. Although these disks are rectangular or other shapes instead of the circular shape used for the conventional disk, it is still belonged to the category of disk from the standpoint of broad definition of a disk.

Usually, a side of the disk is provided with magnetic rails for storing data only and the other side thereof is attached with an adhesive label without any magnetic rail such that the content of the data stored in the disk can be shown in the label. Of course, both sides of some disk, such as the LD, can be stored data and the label is attached to the central part of either side of the disk. A personalized disk is adhered with a label after a recording procedure being complete. The center of the disk usually is provided with a circular hole of standard size for fitting with a reader or a player.

Basically, the label can be adhered to the disk manually with hands, but it is possible to result in that the label may be adhered improperly and inaccurately. Hence, it is preferable to perform the adhering job by way of a tool.

A prior art, U.S. Pat. No. 5,902,446 entitled “LABELER APPARATUS AND METHOD Of APLLYING SELF-ADHESIVE LABELS TO COMPACT DISK”, has disclosed a tool for adhering the label on a disk. However, the prior art provides a sophisticate arrangement for the device so that it generates a high production cost and occupies a greater space in operation.

### SUMMARY OF THE INVENTION

An object of the present invention is to provide a label stuck device for disks, which offers simplified parts and a better performance for adhesive labels being attached to the disks.

### BRIEF DESCRIPTION OF THE DRAWINGS

The present invention can be more fully understood by referencing to the following description and accompanying drawings, in which:

FIG. 1 is an exploded perspective view of a label stuck device for disks according to the present invention;

FIG. 2 is a perspective view illustrating the label stuck device of the present invention for a standard disk; and

FIG. 3 is a perspective view illustrating the label stuck device of the present invention for a small disk.

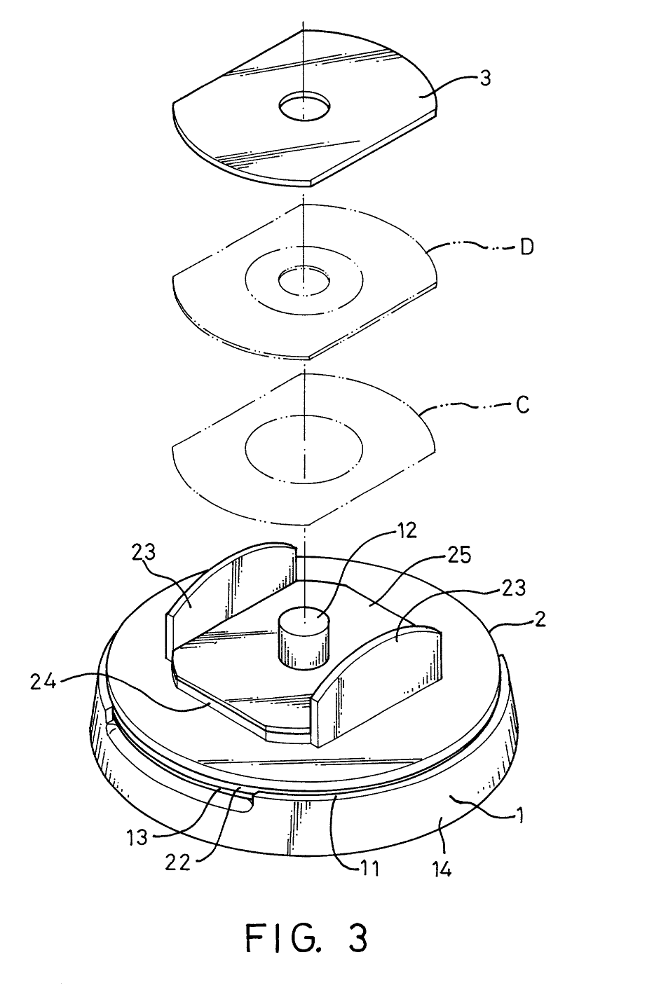

### DETAILED DESCRIPTION OF THE PREFERRED EMBODIMENTS

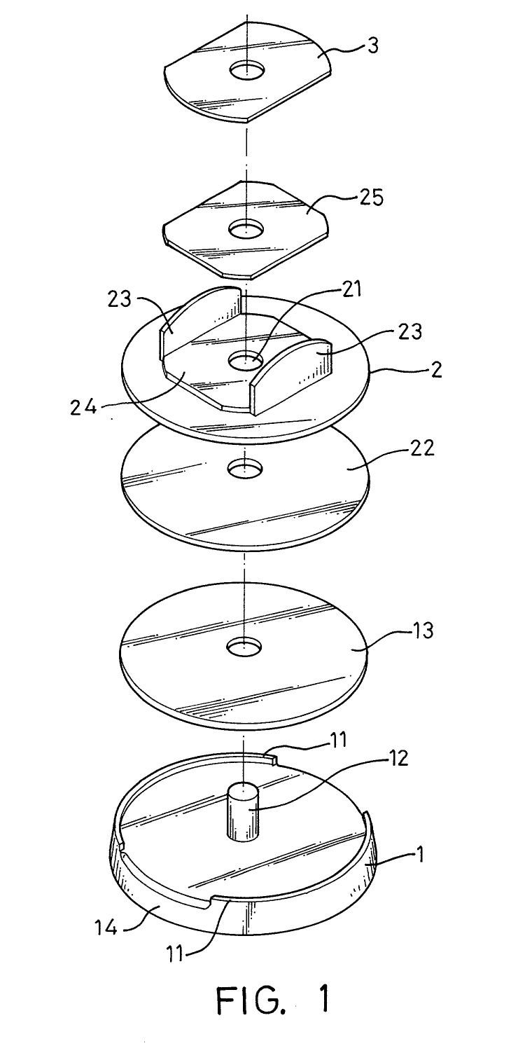

Referring to FIG. 1, a label stuck device of present invention comprises a base part 1, a cover part 2, and/or a press part 3.

Wherein, the base part 1 is circular and the periphery of the base part 1 provides an upright projection rim 11. The upright projection rim 11 can be arranged to surround the periphery or to equally space apart into sections. For instance, the upright projection rim 11 shown in FIG. 1 is separated into two sections, and this is only an example not for a restriction. The upright projection rim 11 is arranged for confining the disk so that an inner diameter of the upright projection rim 11 has to be not less than an outer diameter of the standard disk, i.e., 12 cm. In this way, the disk can be disposed within the area confined by the upright projection rim 11. A central locating post 12 is integrally made with the base part 1 and the diameter of the central locating post 12 has to be corresponding to the 15 mm central hole in the standard disk and extends outward a proper length.

In order to obtain a better tightness, an elastic interlayer 13 may be disposed to attach on the surface of the base part 1. Besides, the periphery of the base part I may extend downward a base border 14 to be feasible for operation i1s from the standpoint of human engineering.

The cover piece 2 has a central positioning hole 21 corresponding to the locating post 12 and has an outer diameter corresponding to an inner diameter of the preceding projection rim 11 so as to be received within the projection rim 11. In addition, an elastic cover pad 22 can be disposed below the cover 2 to enhance the tightness of the stuck label.

In the mean time, in order to be adaptable for the small disk, two upright edge plates 23 are disposed oppositely on the cover part and equally spaced with respect to the positioning hole 21. The distance between the opposite edge plates 23 is arranged to correspond to the standard width of the small width, i.e., 5.8 cm, such that the small width can be fit between the edge plates exactly. Besides, a flat bearing plate 24 may be integrally made with the edge plates and disposed over the cover part 2 with a soft pad 25 to assure a tight attachment.

The press part 3 is a plate with a size preferably corresponding to the small disk so that the width thereof is equal to the distance between the edge plates 23. The purpose of press part 3 is to attach the adhesive label to the small disk.

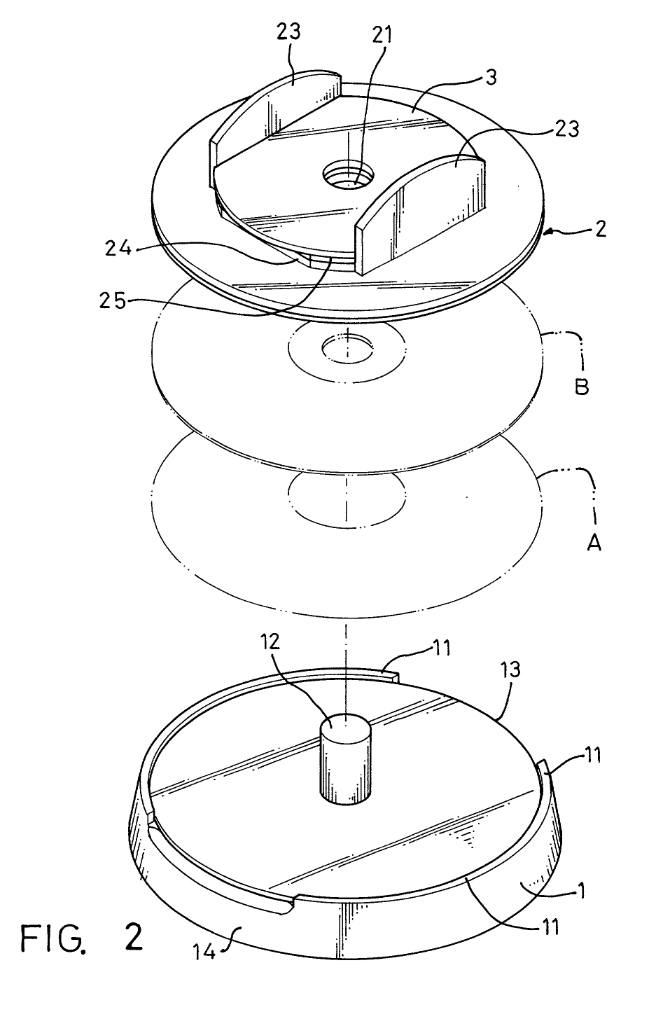

Referring to FIG. 2, while an adhesive label A is going to be attached to the standard disk, the glue side of the adhesive label A is arranged to face upward and a central hole thereof is passed through by the locating post 12. Then, the disk with the side going to be stuck the label A is faced downward and a central hole thereof is passed through by the locating post 12 too. Finally, the positioning hole 21 at the center of the press cover 2 is passed through by the locating post 12 and a press force is exerted may result in the label A is tightly adhered to the disk B.

As a small adhesive label C is going to be stuck to a small disk D, the label C with a glue side thereof is arranged to face upward and fits with the locating post 12 at the end part thereof extending beyond the cover part 2 and is disposed on the bearing plate 24. Then, the small disk D is arranged to face downward with the central hole thereof fitting with the locating post 12. Finally, press down the press part 3 to complete the adhering job.

It can be understood that the present invention provides a label stuck device not only for a standard disk but also for a small disk. It is not possible for a conventional label stuck device to reach the feature effectively.

While the invention has been described with reference to preferred embodiments thereof, it is to be understood that modifications or variations may be easily made without departing from the spirit of this invention, which is defined in the appended claims.

What is claimed is:

1. A label stuck device for disks, comprising
a base part with a circular periphery and a center, providing a or a plurality of upright rim projections on the periphery, an inner diameter enclosed by the rim projection or the rim projections corresponding to an outer diameter of first one of the disks, and providing an integral locating post extending upright from the center with an outer diameter thereof corresponding to a central hole of the first one disk; and
a cover part with a circular periphery and an central axial hole, providing an outer diameter thereof corresponding to the outer diameter of the first one disk, the central hole thereof having a diameter corresponding to the outer diameter of the locating post, providing two opposite upright edge parts and equally spaced to each other with respect to the axial hole with a distance between the edge parts corresponding to a width of a second one of the disks;
whereby, a glue side of a label is arranged to face upward with a central hole thereof passed through by the locating post, the first disk is faced downward to be passed through by the locating post, and a press force is exerted to the press cover fitting with the locating post to allow the label being tightly adhered to the first disk; and the second disk is pierced through by the locating post in a way of facing downward to perform the label adhering job.

2. The label stuck device for disks according to claim 1, wherein press part is provided to press the second disk.

3. The label stuck device for disks according to claim 1, wherein the base part extends downward a base border.

4. The label stuck device for disks according to claim 1, wherein an elastic interlayer is added on the base part.

5. The label stuck device for disks according to claim 1, wherein a cover pad with elasticity is added under the cover part.

6. The label stuck device for disks according to claim 1, wherein a flat bearing plate is integrally made with the edge plates and disposed on the base part.

7. The label stuck device for disks according to claim 1, wherein a soft pad is added on the bearing plate.
